(19) United States
(12) Patent Application Publication
(10) Pub. No.: US 2016/0034258 A1
(43) Pub. Date: Feb. 4, 2016

(54) System and Methods of Generating Build Dependencies Radiator

(71) Applicant: Lexmark International Technology S.A., Meyrin (CH)

(72) Inventors: Seferinus Johnnes Maria Wijngaard, Apeldoorn (NL); Emiliano Jose Martinez Rivera, Apeldoorn (NL)

(21) Appl. No.: 14/815,658

(22) Filed: Jul. 31, 2015

Related U.S. Application Data
(60) Provisional application No. 62/031,363, filed on Jul. 31, 2014.

(51) Int. Cl. G06F 9/44

(52) U.S. Cl. CPC G06F 8/22; G06F 8/73

(57) ABSTRACT

A method of generating an information radiator indicating module dependency relationships includes retrieving a collection of modules forming an application program from an integration server; determining in the collection a plurality of base modules and one or more modules dependent on an output of each base module; and displaying on a web page a dependency layout of the collection of modules, the dependency layout based upon a plurality of dependency relationships between each of the determined plurality of base modules and the one or more modules dependent on the output of each base module.

### CROSS REFERENCE TO RELATED APPLICATIONS

The present application is related to and claims priority from U.S. provisional patent application 62/031,363, filed Jul. 31, 2014, entitled, “SYSTEM AND METHOD OF GENERATING BUILD DEPENDENCIES RADIATOR,” the content of which is incorporated by reference herein its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure generally relates to generating radiators and, more particularly, to generating radiators showing dependency relationships between software builds and a status of each software build.

2. Description of the Related Art

Presenting information in a visually descriptive manner such as in graphs, charts, object diagrams, and the like, often gives the target audience a clearer perspective regarding the subject matter. By showing information in this manner, the interest of the audience may be captured immediately, and the information may be easily conveyed and retained. The challenge in presenting information, therefore, may lie on the selection of data significant to the target audience and on picking a most suitable method for presenting the selected data.

In software engineering, progress in the development of software—per functional component, for example—is typically tracked. By constantly tracking progress, the latest status of the development may be identified, and any problems may be immediately corrected. The practice of continuously integrating components to software prior to deployment is more commonly known as continuous integration (CI). Development systems practicing CI may include tools that help software developers and/or testers integrate the latest developments of the software (e.g., updated code, test results, etc.) to a facilitating server.

Aside from tools for managing a software development workflow, current CI systems may also include tools for generating information based on a latest set of data, such as in an information radiator. A radiator may refer to a tool for presenting relevant information associated with the software being developed that is displayed in an area conspicuous to the software development team and to other involved or interested parties. Using radiators, information related to the software being developed may be automatically to shown and interpreted, and appropriate responses to certain actions may be performed immediately. A radiator may be, for example, a summary or list of modules, a build pipeline or a dependency graph, and may include module identifiers, status indicators (e.g., build fail, success, ongoing, etc.), dependency relationship indicators, as well as other information that may be relevant to the development team.

Current CI systems, however, may lack sufficient information and/or may include data that may be irrelevant to those involved in software development. Moreover, some existing tools for generating dependency graphs may only show progress of each build in the software, such as in a single pipeline. In such cases, there is, therefore, a problem in generating a dependency graph of a single build stemming from a plurality of starting builds or a dependency graph which shows more meaningful relationships between builds as they are developed, tested, or integrated into the software. Other examples of radiators for tracking progress in a software development process are apparent in the art and may also present the same or at least similar problems.

Accordingly, there exists a need for a system and methods of generating radiators that provide a more meaningful set of information which may be, for example, based on a nature or a set of needs of a software development group, department or organization. There is also a need for methods of generating a radiator for software or application projects having interrelated builds. Further, there is a need for a system tool that may be integrated on any CI system for automatically generating radiators relevant to the software development process.

### SUMMARY

A system and methods for generating information radiators indicating status and dependencies between software builds (modules) for integration as an application are disclosed. The system includes a dependency build radiator (DBR) tool that may be integrated with a software development workflow. Methods for generating radiators for display on a web page may include querying an integration server at a predetermined interval for a collection of builds having more than one starting or base jobs and creating a dependency graph based on dependency relationships among the builds in the collection. The dependency graph may be automatically updated and may include build information configurable by the software development group.

In one example embodiment, a method of generating an information radiator indicating module dependency relationships includes retrieving a collection of modules to forming an application program from an integration server; determining in the collection a plurality of base modules and one or more modules dependent on an output of each base module; and displaying on a web page a dependency layout of the collection of modules, the dependency layout based upon a plurality of dependency relationships between each of the determined plurality of base modules and the one or more modules dependent on the output of each base module.

In another example embodiment, a method of generating a status and dependency graph of modules associated with an application includes querying an integration server for module identifiers, each module identifier corresponding to a module in the application; identifying a build status of each module; determining, based on the module identifiers, a dependency relationship of each module with other modules in the application; and generating on a display a dependency graph based on the determined dependency relationships the modules, the dependency graph including the identified build status of each module.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows a system for developing software that practices continuous integration, according to one example embodiment.

FIG. 2 shows one example embodiment of a continuous integration system including a dependency build radiator (DBR) generator tool.

FIG. 3 is a flowchart of one example method for dynamically generating a radiator based on real-time build data.

FIG. 4 shows one example embodiment of a placeholder for a build as shown in a radiator.

FIGS. 5-7 and 8A-8B show example embodiments of radiators displaying statuses and dependencies of builds.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is therefore, not to be taken in a limited sense, and the scope of the present disclosure is defined by the appended claims.

Also, it is to be understood that the phraseology and terminology used herein is for the purpose of description and should not be regarded as limiting. The use herein of “including”, “comprising”, or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other data processing apparatus may create means for implementing the functionality of each block or combinations of blocks in the diagrams discussed in detail in the description below.

These computer program instructions may also be stored in a non-transitory computer-readable medium that may direct a computer or other programmable data to processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are a system and methods for generating build status and dependency radiators for display on a browser. Methods for generating the radiators may include retrieving a collection of jobs from a server at a predetermined interval for automatically updating a radiator displayed on a browser web page or generating one at a first instance. A radiator's layout may be based on the dependency relationships of jobs or builds in the retrieved collection and may be dynamic The radiator may include information that may be customized according to, for example, a type of view the target audience may be in need of or request for.

In the present disclosure, the terms “job” and “build” may be used interchangeably. A job or a build may refer to a particular functional unit in the software or application being developed. The job or build may be, for example, a set of code such as a program method submitted by one or more programmers or developers to the CI system for continuous development or testing. In other example embodiments, a build may refer to a job already in the CI system and is undergoing a series of processes typical in a software development workflow, i.e., compilation; execution; testing phase (e.g., bug-related or code structure-centric errors before, during, or after execution); version control; and the like.

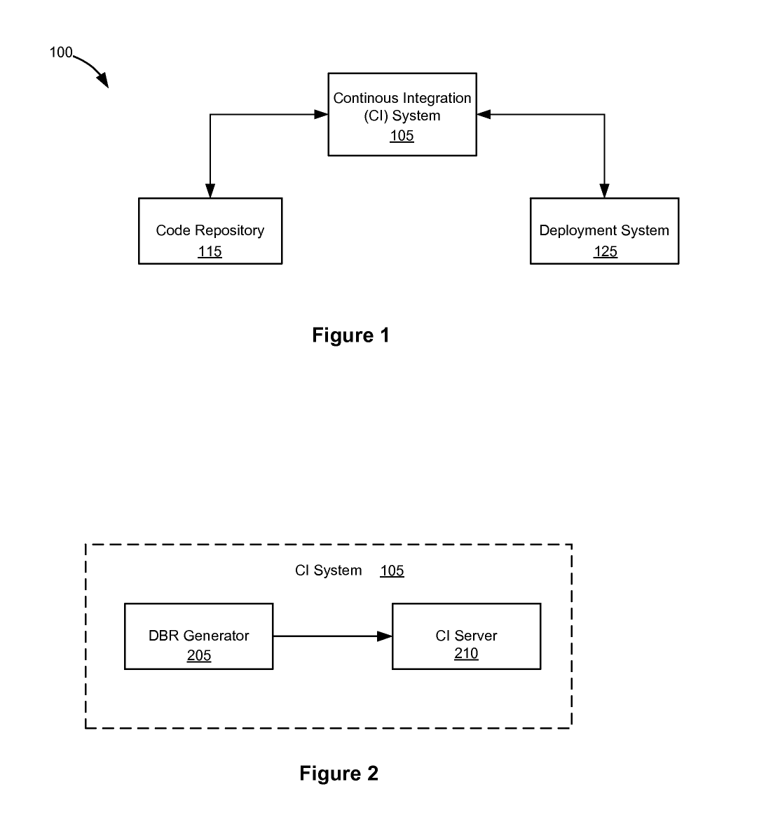

FIG. 1 shows one example embodiment of a software development workflow or system 100 for developing software or application projects. System 100 may also be used for testing committed jobs and providing test results. System 100 may include a continuous integration (CI) system 105 for managing builds in system 100. Further, system 100 may include a code repository 115 for storing the jobs or builds developed and committed by developers. System 100 may also include a deployment system 125 for deploying successful builds to appropriate receivers. Developers as well as testers utilize a client device such as, for example, a personal computer, a mobile device, or like computing devices that includes at least a processor, a memory, and a computer-readable medium for developing and for testing the jobs. Any set of code or program instructions committed by developers to code repository 115 may be referred to as a job in system 100. An executed job in CI system 100 may be referred to as a build, as will be described in detail below. Combinations and permutations for the elements in system 100 may be apparent in the art.

Connections between the aforementioned elements in FIG. 1 depicted by the arrows may be communication links that are part of a network allowing communications between two or more computing systems, as discussed herein, and/or available or known at the time of the filing, and/or as developed after the time of filing. The network may be, for example, a communications network or network/communications network system such as, but not limited to, a peer-to-peer network, a Local Area Network (LAN), a Wide Area Network (WAN), a public network such as the Internet, a private network, a cellular network, and/or a combination of the foregoing. The network may further be a wireless, a wired, and/or a wireless and wired combination network.

CI system 105 may be any continuous integration system streamlined to a software development workflow. CI system 105 may consist of a set of tools and/or processing devices (e.g., servers) for managing jobs or builds in system 100. Moreover, CI system 105 may be comprised of one or more components for performing one or more specific functions concerned with the management of jobs in system 100. For example, the components may perform the following functions: compilation of jobs, execution of jobs, testing of jobs, retrieval of new jobs and/or updating versions of jobs or builds stored in content repository 115, versioning of builds, generation of reports and/or radiators, deployment and/or integration of successful builds to the software being developed, and/or the like. CI system 105 may include a web application accessible by developers, one or more testers, and other parties involved in the software development workflow for determining progress of the software being developed.

In one example embodiment, CI system 105 may retrieve jobs from content repository 115. Jobs submitted by developers and stored in content repository 115 (i.e., “newly committed code”) may be retrieved by CI system 105 on a regular basis. Content repository 115 may also store updated version of jobs that include modified portions or an additional set of code based on, for example, a latest set of testing results. For example, CI system 105 may communicate with content repository 115 at predetermined intervals for any new or updated jobs.

In other example embodiments, content repository 105 may update CI system 105 with any new or updated jobs for retrieval by the CI system. In another aspect, content repository 115 may be operative to automatically send new or updated jobs to CI system 105. This way any errors in a build may be detected immediately, and one or more appropriate actions for correcting the errors on the build may be performed prior to deployment of the build and/or its integration to the software. CI system 105 may be communicatively connected to deployment system 125 which may include one or more servers for deploying successful builds to one or more appropriate receivers such as, for example, a particular client device or an appropriate application. Deployment system 125 may include one or more program instructions for integrating one or more builds to the software or the application project being developed; archiving or versioning successful builds; and/or converting successful builds into executable data objects or files. How jobs are deployed in system 100 may be predetermined by an administrator such as an application owner or a team lead of the CI system.

It may be apparent to those skilled in the art that system 100 may also include a repository for storing one or more artifacts, referring to any material produced at any part in system 100. The one or more artifacts may be, for example, object diagrams, code scripts, job metadata and/or the like. A documentation file of each successful and/or failed build may also be contained in the artifact repository. In this same context, documenting about each job or build on CI system 105 may be a separate process in system 100 which may be performed before or in parallel with the deployment of builds.

FIG. 2 shows one example embodiment of CI system 105 according to one example embodiment. In the present disclosure, CI system 105 may include a dependency build radiator (DBR) generator 205 for generating radiators and a CI server 210 for storing jobs and/or builds in system 100. DBR generator 205 and CI server 210 may be communicatively connected to each other through a network that may be wireless, wired, to and/or combination of wireless and wired, such as that of the network in FIG. 1. DBR generator 205 may communicate with CI server 210 over the network for determining new jobs or any updates of existing builds in system 100 and for generating radiators. DBR generator 205 may create a new radiator at a first instance of communication with CI server 210 or update the existing radiator. Alternatively, DBR generator 205 may be residing on CI server 210.

DBR generator 205 may be a tool (i.e., a plug-in or add-on) that accesses CI server 210 for new jobs and/or updated builds to be used for generating radiators. CI server 210 may be comprised of one or more servers, which may include, but are not limited to, a personal computer, a mainframe computer, a web server, or a series of servers for hosting one or more program instructions on system 100. Particularly, CI server 210 may include a set of information associated with a build on system 100. The set of information may be generic for all jobs or builds on system 100 or specific to one or more particular jobs or builds. Other tools besides DBR generator 205 may be integrated to CI system 105 for performing one or more specific functions or features thereon.

CI server 210 may include a database or any data storage mechanisms for organizing jobs and builds and information associated with them, such as metadata. As is known in the art, the database may employ one or more structuring techniques for organizing information such as in tables, indexes, context maps, and the like. The database may also store other information used in system 100 such as, for example, profile accounts of users of CI system 105, development-related artifacts, and/or the configuration settings of CI system 105. CI server 210 may further include an application such as a database management system for managing stored information associated with CI system 105. In other example embodiments, functionalities performed by CI server 210 may be performed instead by code repository 115.

With reference still on FIG. 2, an interface may be accessed by any party involved in system 100 (e.g., a developer) for communicating with CI system 105 and for generating or loading the radiator/s. In one example embodiment, the interface may be a browser of a client device for use by a developer. The browser may be used for accessing a web page and invoking DBR generator 205 for one of loading or updating a build status and dependency radiator on the web page. The web page may be accessed by invoking a graphical user interface (GUI) object (e.g., link, tab, button, icon, or caption) on the browser; to entering a location identifier for the radiator web page, such as a file URL on an address bar on the browser or any other methods for accessing a web page as is apparent in the art. In other example embodiments, CI system 105 may include a web application for accessing the web page. A URL of CI system 105, for example, may be entered through the browser for loading the web page having the radiator.

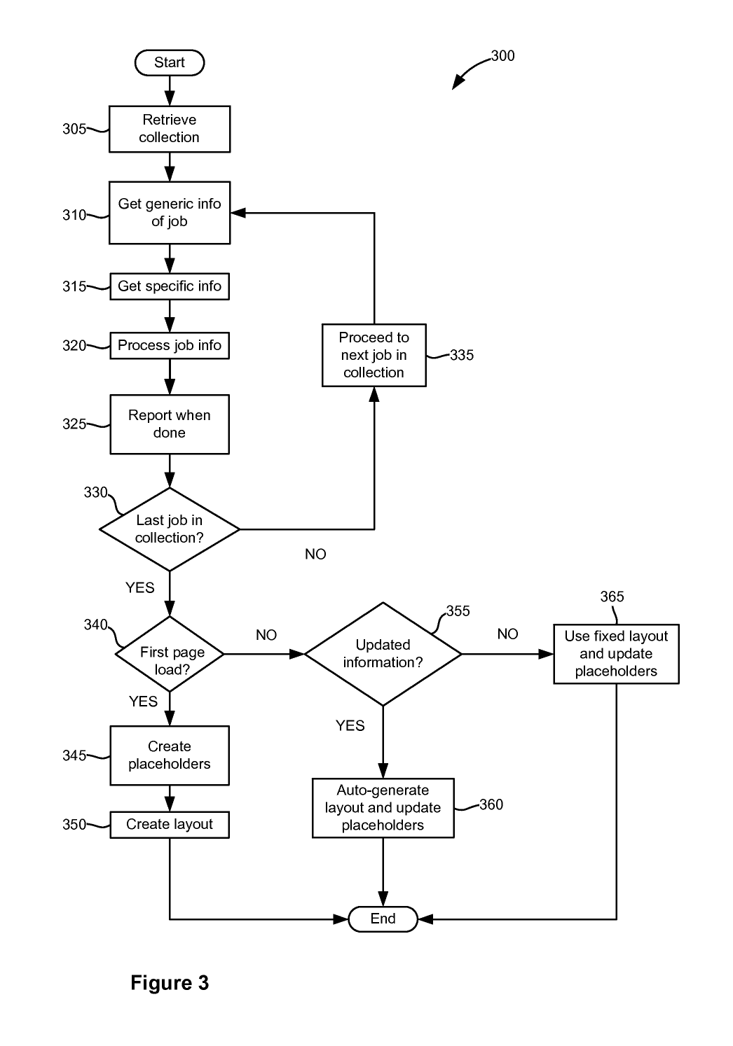

FIG. 3 is a flowchart of a method 300 for dynamically generating a radiator based on data from CI server 210. Method 300 may be performed by DBR generator 205. At block 305, DBR generator 205 may retrieve a collection of jobs and/or builds from CI server 210. A collection of jobs may refer to the jobs retrieved by CI system 105 from content repository 115. The collection of jobs may include one or more pending jobs, one or more jobs that are being executed or are already processed (i.e., ongoing build) and/or would still undergo further processing (successful or failed build), as will be described in more examples below.

Retrieving the collection of jobs may include communicating with CI server 210. Communicating with CI server 210 may be performed by: (1) entering an address (e.g., URL) of the CI server on the browser address bar or (2) incorporating the address of the CI server as one or more instructions on a web page (e.g., HTML file), such that every time the web page is loaded on the browser, a connection may be established with CI server 210 for querying the collection of jobs. The collection of jobs or builds may be shown in a list format.

In one example embodiment, the retrieved collection of jobs may include an identifier for each job or build. The job or build identifier may be, for example, a build number, a name, or the like. In other example embodiments, the jobs or builds in the collection may be arranged in a particular manner, such as, for example, according to a size, a hierarchy of dependency relationships (e.g., a new and second current job is dependent on first current build X), and the like. One or more program instructions on CI system 105 may be configured to identify which jobs or builds may be processed in parallel, are dependent on the same jobs or builds, and other factors.

Blocks 310 to 335 of method 300 pertain to the retrieval of generic and specific information for each job in the retrieved collection. In one example embodiment, the retrieval and processing of information for each job or build in the collection may be performed asynchronously. For example, information associated with each job or build in the to collection may be retrieved and/or processed from CI server 210 at an irregular rate or particular data intervals.

For each job in the collection retrieved in block 305, the generic and then the specific set of information may be retrieved by DBR generator 205 from CI server 210 (blocks 310 and 315). The generic set of information for a job may refer to types of identifiers common across the jobs or builds in the retrieved collection, such as a name indicative of a module group the job or build may be classified in (e.g., moduleOne_elegant, moduleOne_studio), a status identifier (e.g., ongoing compilation, ongoing testing), and a health condition (e.g. successful or failed), among others. The specific set of information may refer to information unique to a particular job, such as, for example, the job execution time.

Further, retrieving the generic and the specific set of information from CI server 210 may be performed separately. For example, a first instance of communication (e.g., a program call) to CI server 210 may be a request for the retrieval of a generic set of information associated with a job in the collection; upon retrieval of the generic set of information, a second instance of communication to CI server 210 may be communicated to retrieve a specific set of information associated with the same job. An identifier of a job or build based on the retrieved collection may be used in retrieving information associated with each job. Additionally, information regarding the collection or a particular job included thereof may be communicated from CI server 210 to the DBR generator 205 as one or more data objects having a format standard for recognition by a web page in a browser or in the alternative, by the web application wherein the radiator is to be displayed.

At block 320, job information retrieved from CI server 210 may be processed. Processing information retrieved from CI server 210 may include converting the one or more data objects to human-readable text for display in the web page. In other example embodiments, information retrieved from CI server 210 may include encrypted data. DBR generator 205 may include one or more program instructions for decrypting the data to be used by the web page in the radiator.

At block 325, the web page where the radiator may be displayed may send a report such as a signal or notification to DBR generator 205 indicating that a transmission of information for a particular job is done. The notification may also indicate, for example, an identifier of the job or build being processed such as an index number of the job in the retrieved collection, a primary key associated with the job as it is stored on the database, and the like. At block 330, it is then determined whether a current job being processed is the last job in the collection of jobs retrieved at block 305. If not, the next job in the collection may be processed (block 335) and information associated with the next job may also be collected and processed from blocks 315 to 330. It may be apparent in the art that the information retrieved and processed may be based on a latest set of information regarding the builds in the CI system as they are stored or updated in CI server 210.

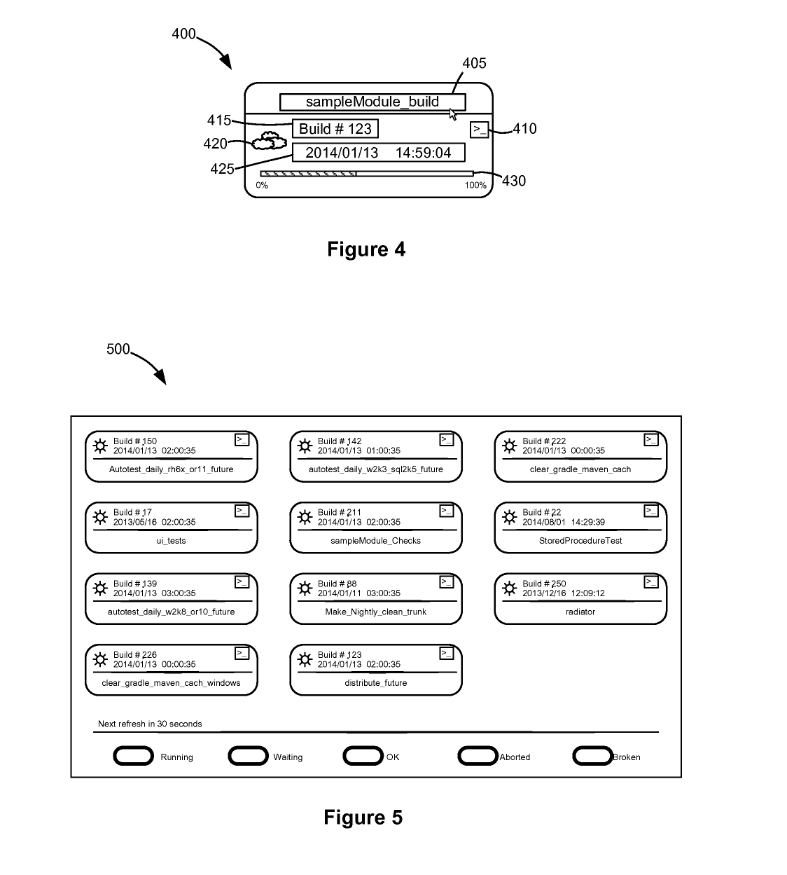

FIG. 4 shows an example placeholder 400 for a job in the radiator to be displayed in a web page on a browser. Placeholder 400 may be a GUI component of the radiator displayed in the web page, such as a box. Placeholder 400 associated with a particular job may include the following information: a build name 405, an output icon 410, a build number 415, a health icon 420, a timestamp 425, and/or a progress bar 430, among others. In this example embodiment, build name 405 may be a link such as a hyperlink that may be invoked (i.e., clicked) for communicating with a location of the build as it is stored in CI server 210 and accessing the set of code or program instructions associated with the build. Output icon 410 may be a GUI component that may be selected for launching a console output displayed after executing the job on CI system 105. The console output may be, for example, a series of characters generated upon execution of the said job. The console output may be indicative of a condition of the build, which may include: stable or unstable, broken, failed, or successful build. Build number 415 may be indicative of a numerical identifier based on a job hierarchy, a version number, and the like of a particular build or job. Health icon 420 may be indicative of a state of a last n number of executions for the build. Health icon 420 may be based on the state of the latest execution of the job or build and may be, for example, depicted by a cloud, raindrops, or a sun icon. Timestamp 425 may include a date when the last processing or execution of a particular job took place and/or a time it took for the particular job to be processed. Optional progress bar 430 may be shown when the job is being processed (e.g., compiled, executed, etc.) or a build process is taking place for such job at/almost real-time at CI server 210.

It may be apparent in the art that the information displayed on placeholder 400 may be dependent on how the radiator may be set by an administrator or user of system 100. In other example embodiments, information displayed on placeholder 400 may be dynamic. For example, the set of information on placeholder 400 may be reduced when a build is to successful or added when a build is ongoing or continuously failing. How much information presented on placeholder 400 or how dynamic it is may be dependent, for example, on a nature or needs of the parties involved in the software development workflow system 100.

Referring back to FIG. 3, remaining blocks 340 to 365 pertain to generating a layout or structure of the radiator based on the processed information of each job in the collection. At block 340, DBR generator 205 may determine whether the web page for displaying the radiator is executed at a first instance on the browser, for example. If so, a radiator may be automatically generated on the web page based on the retrieved job collection and associated information thereof. Generating the radiator on the web page may include creating a placeholder such as placeholder 400 for each job in the collection (block 345) and/or positioning each job in the radiator (block 350). Positioning jobs in the radiator being displayed may include determining whether a first job is upstream or downstream of a second job. For example, a particular job may be dependent on a second job (upstream job) but may also have a third job dependent on it (downstream job). The particular job may need an output from the upstream job, while the downstream job may be dependent on an output of the particular job, such that the downstream job is an integration of outputs from both said particular job and the upstream of the particular job. These relationships of a particular job with other jobs that are part of the software development workflow may be shown through the interconnections of the jobs in the radiator. A most downstream job in the radiator may be an integration of all successful builds and outputs thereof in CI system 105.

In one example embodiment, how the jobs or builds may be positioned in the radiator may depend on whether or not the one or more jobs in the collection are interrelated with each other. For example, a layout of a collection of jobs that have no dependencies may be displayed as a grid of placeholders with no connections. Otherwise, jobs or builds having dependencies may be shown through placeholders that are interconnected by connecting elements (i.e., lines, arrows, etc.), such as, for example, placeholders positioned in a vertical pipeline-like layout.

FIG. 5 illustrates one example embodiment of a radiator for a collection of jobs that have no dependencies shown in a grid-like layout. In one example embodiment, the collection of jobs shown in the radiator web page may include a job associated with DBR generator 205, such as Build #250 or “radiator” job shown in FIG. 5. Such build may be utilized, for example, to determine a real-time status of DBR generator 205 (e.g., needs updating, ongoing, failing), auditing DBR generator 205 for code bugs, and/or updating DBR to generator 205 to a new version.

Blocks 355 to 365 may be performed upon loading the radiator web page for at least the second or n number of time(s). In other example embodiments, the web page having the radiator may be configured to load automatically upon determination that there is new information on the jobs stored on CI server 210. The web page may be configured to load automatically at a regular basis such as, for example, every 10 seconds. In yet other example embodiments, DBR generator 205 may include program instructions for automatically loading the web page having the radiator when updated information is determined to be available on CI server 210. Alternatively, DBR generator 205 may only communicate with CI server 210 and update the displayed radiator when the web page having the radiator is being loaded by the user.

With reference still on blocks 355 to 365, DBR generator 205 may further determine whether there any updates on the information of each build on the previously loaded radiator at block 355. Such determination may be based on the retrieved collection of jobs at block 305. More so, the determination whether the radiator may be updated or altered may be based on whether or not one or more jobs are added in the collection and/or any of the one or more builds changed in status in the process. Jobs that are added in the collection may pertain to newly-committed jobs or jobs that are acted upon as a result of a successful upstream job (new or ongoing builds). When it is determined that there are updated information on the retrieved collection, new placeholders for the new jobs or builds may be generated and added into the current layout of the radiator for displaying in the web page (block 360). In other embodiments, a new layout of the radiator may be auto-generated to show a relationship of the new job with the current jobs and/or placeholders of existing fields citing new information may be changed, if any update is available. Otherwise, when it has been determined at block 355 that there are no updates on the retrieved collection, the current layout of the radiator remains, but information of the jobs displayed on their respective placeholders may be updated to the current status of each based on the latest collected data from CI server 210, if any update is available.

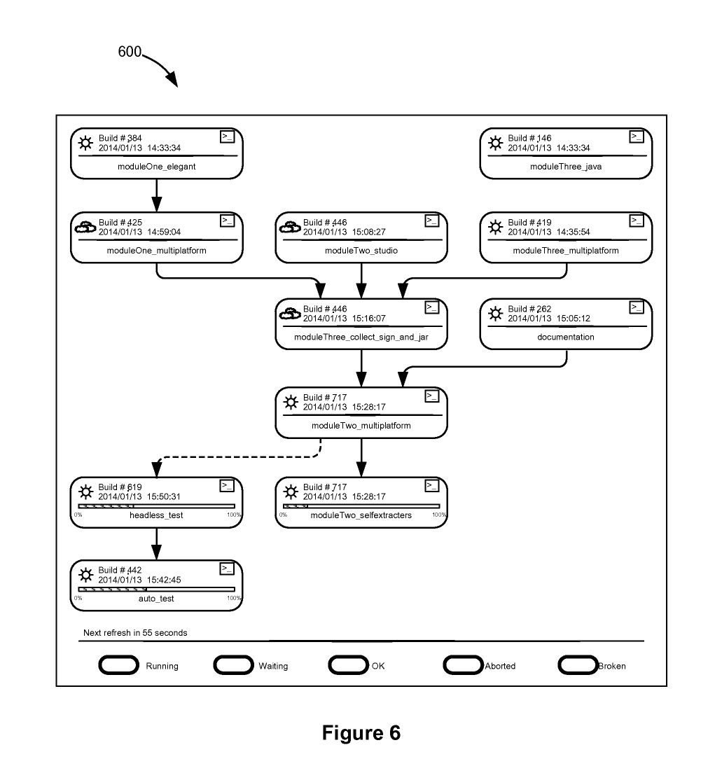

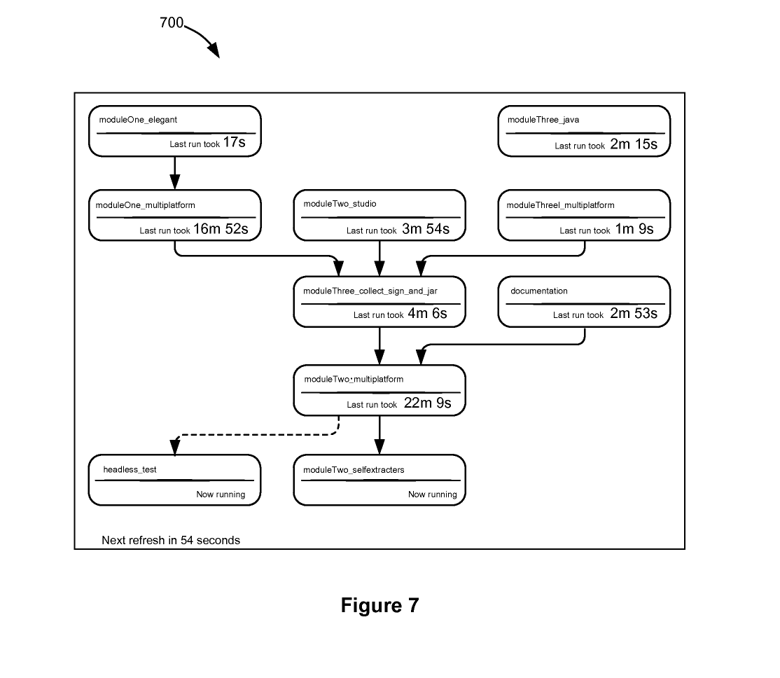

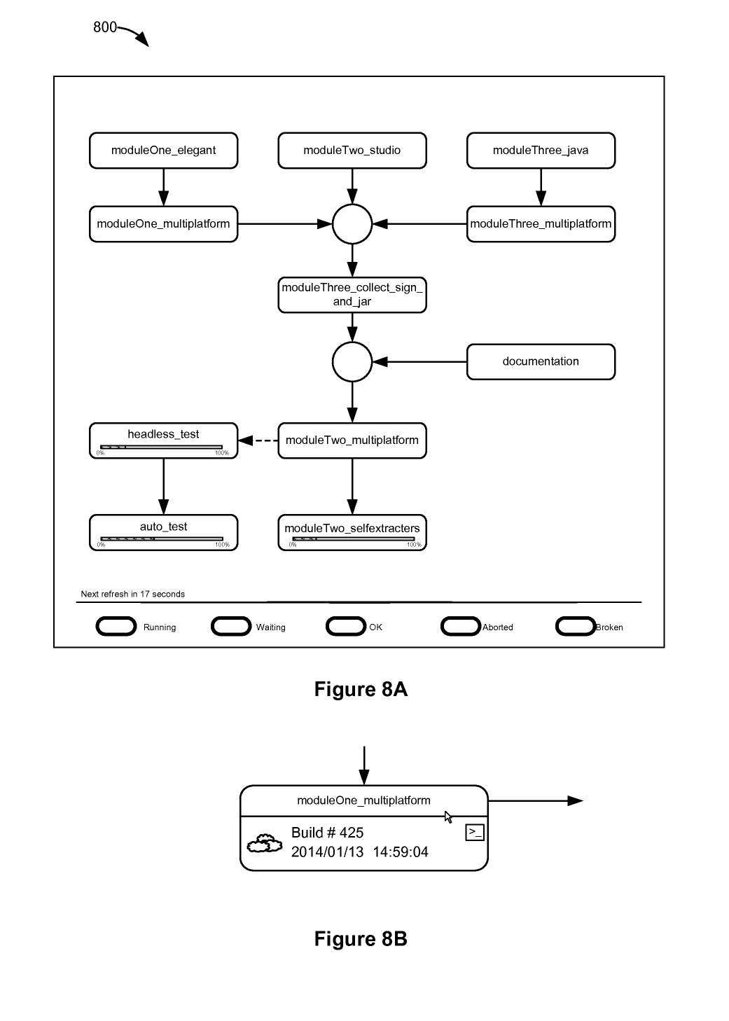

FIGS. 6, 7 and 8A-8B show other example embodiments or views of the radiators generated in the present disclosure including placeholders that contain information on respective jobs or builds as well as their dependency relationships. FIG. 6 shows a radiator including an extended view of the information regarding each job. Respective placeholders of each job in the example embodiment in FIG. 6 includes at least, build name to 405, output icon 410, build number 415, health icon, and timestamp 425 corresponding to the job or build, while FIG. 7 shows preselected information for each job in the collection, which comprises build name 405 and a running time of a job. FIG. 8A shows a simplified radiator of the present disclosure including a hover function, such that when a job is selected, information for that job is shown (as depicted on FIG. 8B). In the same example embodiment, FIG. 8A, primarily shows on top of the dependency relationships shown by connecting elements build name 405 for each job. Once selected, the placeholder of corresponding to the selected job may be expanded to show other information associated with the same job which includes output icon 410, build number 415, health icon 420, and timestamp 425, as depicted by FIG. 8B.

In the example radiators depicted by FIGS. 6-8B, the one or more most downstream builds in the example radiators may include an executable file for deployment system 125. The executable file may be, for example, a test installer for execution on an operating system native to system 100 (i.e., “headless_test”). Alternatively, one or more executable files for execution on other appropriate computing environments such as other operating systems (e.g., “moduleTwo_selfextracters”) may also be included in the most downstream jobs. One or more artifacts (i.e., documentation file) associated with the collection or any of the builds may also be included in the most downstream jobs in the generated radiator.

It will be understood that the example embodiments described herein are illustrative and should not be considered limiting. It will be appreciated that the actions described and shown in the example flowcharts may be carried out or performed in any suitable order. It will also be appreciated that not all of the actions described in FIGS. 3-5 need to be performed in accordance with the example embodiments of the disclosure and/or additional actions may be performed in accordance with other example embodiments of the disclosure.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of generating an information radiator indicating module dependency relationships, comprising:
retrieving a collection of modules forming an application program from an integration server;
determining in the collection a plurality of base modules and one or more modules dependent on an output of each base module; and
displaying on a web page a dependency layout of the collection of modules, the dependency layout based upon a plurality of dependency relationships between each of the determined plurality of base modules and the one or more modules dependent on the output to of each base module.

2. The method of claim 1, wherein the retrieving the collection of modules includes querying the integration server for a set of information associated with each module in the collection.

3. The method of claim 2, wherein the querying the integration server is based upon a list of module identifiers, wherein each module identifier in the list is associated with one of the modules.

4. The method of claim 1, wherein the retrieving the collection includes identifying a most current build status of each module in the collection.

5. The method of claim 1, further comprising loading the web page for displaying a dependency layout based on an updated collection of modules from the integration server.

6. The method of claim 1, wherein the retrieving the collection is performed at a predetermined interval for determining whether the collection of modules from the integration server includes an updated set of build data and upon a positive determination, performing the determining and the displaying using the updated set of build data.

7. A method of generating a status and dependency graph of modules associated with an application, comprising:
querying an integration server for module identifiers, each module identifier corresponding to a module in the application;
identifying a build status of each module;
determining, based on the module identifiers, a dependency relationship of each module with other modules in the application; and
generating on a display a dependency graph based on the determined dependency relationships of the modules, the dependency graph including the identified build status of to each module.

8. The method of claim 7, wherein the querying is performed at a predetermined interval and determines whether an updated set of build data is available on the integration server.

9. The method of claim 8, wherein the identifying, the determining the dependency relationship, and the generating are performed on the updated set of build data upon a positive determination that the updated set of build data is available.

10. The method of claim 7, further comprising automatically updating on the display the dependency graph when the updated set of build data is available.

11. The method of claim 7, wherein the determining the dependency relationship includes identifying whether each module is one of a base module and a module dependent on the base module.

12. A non-transitory computer-readable storage medium storing one or more instructions that, when executed by a computer, cause the computer to perform a method for generating a dependencies graph, the method comprising:
querying an integration server for a collection of modules, each module in the collection including information associated with a build status of the module;
determining, based upon the collection of modules, a plurality of base modules and one or more modules dependent on an output of each base module; and
displaying on a web page a dependency graph based on a plurality of dependency relationships between each of the plurality of base modules and the one or more modules to dependent on the output of each base module.

13. The non-transitory computer-readable storage medium of claim 12, wherein the dependency graph includes information associated with a build status of each module in the queried collection.

14. The non-transitory computer-readable storage medium of claim 12, wherein querying is performed at a predetermined interval and determines whether an updated set of build data for the collection of modules in the integration server is available.

15. The non-transitory computer-readable storage medium of claim 14, wherein the method further comprises updating the dependency graph on the display upon determining that the updated set of the build data is available.

16. The non-transitory computer-readable storage medium of claim 12, wherein the displaying includes generating an interface placeholder for each module included in the dependency graph, the interface placeholder including information associated with the module displayed in human-readable text.

17. The non-transitory computer-readable storage medium of claim 12, wherein the displaying the dependency graph includes determining whether each module in the collection is a base module and, upon a positive determination, displaying the collection of modules in a grid layout.

18. The non-transitory computer-readable storage medium of claim 12, wherein the displaying the dependency graph includes determining one or more web page interface elements appropriate for each data included in the dependency graph, the one or more web page interface elements include at least one of an icon, a caption, a line, and a color.

19. The non-transitory computer-readable storage medium of claim 18, wherein the one or more web page interface elements is dependent on a build status of a module.

20. The non-transitory computer-readable storage medium of claim 12, wherein a most downstream module in the dependency graph is an executable file, the executable file including instructions from the plurality of base modules and the one or more dependent modules in the collection.
